(19) United States
(12) Patent Application Publication
(10) Pub. No.: US 2010/0076596 A1
(43) Pub. Date: Mar. 25, 2010

(54) Article dispenser

(76) Inventors: Richard Daniel Graham, Little River, SC (US); Barbara Anne Graham, Little River, SC (US)

Correspondence Address: Richard D. Graham, 3103 Ashley Ct., Little River, SC, 29566, US

(21) Appl. No.: 12/586,361

(22) Filed: Sep. 21, 2009

Related U.S. Application Data
(60) Provisional application No. 61/192,553, filed on Sep. 19, 2008.

(51) Int. Cl. G06F 17/00

(52) U.S. Cl. 700/232

(57) ABSTRACT

An apparatus for selectively dispensing articles such as towels and wash cloths. The apparatus includes a housing having a dispensing mechanism for selectively releasing at least one article from one of at least two magazines, and a communication unit interoperable with the dispensing mechanism and the housing. The communication unit has a reader and a selection menu.

### I. FIELD OF INVENTION

The present application is generally related to a dispenser, and more specifically, an article dispenser for discharging a specified quantity of towels, wash cloths, hand towels, and other similar items.

### II. MOTIVATION OF THE INVENTOR

At present, the ability of a patron to secure additional bath towels, hand towels and/or wash cloths from the hotel and its staff is problematic, generally complicated by the many tasks that hotel staff is trying to accomplish, including specific requests of the sort. Usually, a patron may place an internal phone call to the front desk to request additional articles or items. Or, a patron may place the request in person. Unfortunately, the patron is at the mercy of the staff's ability to timely respond to such a request, and often, the request goes unsatisfied or unfulfilled. Additionally, it is customary in many hotel establishments for the patron to “tip” the staff for such requests.

One solution to this issue is to provide patrons with a “self-help” solution, giving the patron the ability to locate a dispensing unit or apparatus and input the request him or herself. This provides an immediate response to the patron's request, and does not tie up the hotel staff with additional responsibilities. Furthermore, the social burden to “tip” staff is removed, thereby saving the patron time, money and avoiding embarrassment.

To be clear, the apparatus, system and method disclosed herein is not limited to hotel articles, but may include other articles of the stackable type capable of dispensing in the manner disclosed herein. Other applications of the apparatus include use at a pool or gymnasium, or other similar facilities.

In response to this challenge, the present application discloses an apparatus, system and method providing immediate response to a hotel patron's request for additional articles or items. In the system and method disclosed herein, a housing retains a plurality of towels and wash cloths, for example, in a stacked arrangement in separate magazine compartments or chambers. Upon the patron's request, one or more articles of one of the types are dispensed through an end of the housing, with the patron exiting the apparatus with his or her request fulfilled.

Thus, a need has been demonstrated for an apparatus, system and method to dispense articles in this manner. As such, the present application discloses a system and a method by which these and other objects are achieved. To applicants' knowledge, there are no other apparatuses, devices or disclosures that provide the arrangement, configuration and features of the apparatus disclosed herein.

A search of the prior art did not disclose any patents that read directly on the claims of the instant invention; however, the following references were considered related.

The following patents disclose various towel and article dispensing systems and apparatuses:

U.S. Pat. No. 4,984,530, issued in the name of Dutton;

U.S. Pat. No. 6,247,612 B1, issued in the name of Kaufman;

U.S. Pat. No. 6,431,111 B1, issued in the name of Zhang;

U.S. Pat. No. 5,167,345, issued in the name of Bleeker;

U.S. Pat. No. D462,215 S, issued in the name of Bartelt et al.;

U.S. Pat. No. 4,173,271, issued in the name of Copp;

U.S. Pat. No. 5,385,265, issued in the name of Schlamp;

U.S. Pat. No. 7,188,748 B2, issued in the name of Snell;

U.S. Pat. No. 7,347,341 B2, issued in the name of Burggraf,

U.S. Pat. No. 6,439,500 B1, issued in the name of Shoenfeld;

U.S. Pat. No. 6,786,333 B2, issued in the name of Davis; and

U.S. Pat. No. 6,223,934 B1, issued in the name of Shoenfeld.

### III. SUMMARY OF THE INVENTION

In one embodiment, an apparatus for dispensing articles comprises a housing having at least two magazines, each magazine having a discharge opening abutted by a selectively openable door; a dispensing mechanism selectively releasing at least one article from one of the magazines; and a communication unit interoperable with the dispensing mechanism and the housing, the communication unit having a reader and a selection menu.

In another embodiment, an apparatus for dispensing articles comprises a housing having at least two magazines, the housing having a removable cover for access to the magazines, each magazine having a discharge opening abutted by a selectively openable door; a dispensing mechanism selectively releasing at least one article from one of the magazines, the at least one article dispensed through the discharge opening and the openable door; a communication unit interoperable with the dispensing mechanism and the housing, the communication unit having a reader and a selection menu; the reader processing information encoded on a storable and portable medium, the information decodable via the reader; and the selection menu having at least an article selection input and a quantity selection input.

### IV. BRIEF DESCRIPTION OF THE DRAWINGS

FIG. 1 is a perspective view of one embodiment of an apparatus installed on a wall;

FIG. 2 is a front view of the embodiment of FIG. 1;

FIG. 3 is a perspective and partially exploded view of FIG. 1;

FIG. 4 is a front and exploded view of FIG. 1;

FIG. 5 is a front view and alternative embodiment consistent with FIG. 4;

FIG. 6 is a front view consistent with FIG. 4 and FIG. 5;

FIG. 7 is a side view showing a deflected member and a platform; and

FIG. 8 is a front view of the communication unit interoperable with the apparatus.

### V. DESCRIPTION OF THE EMBODIMENT(S)

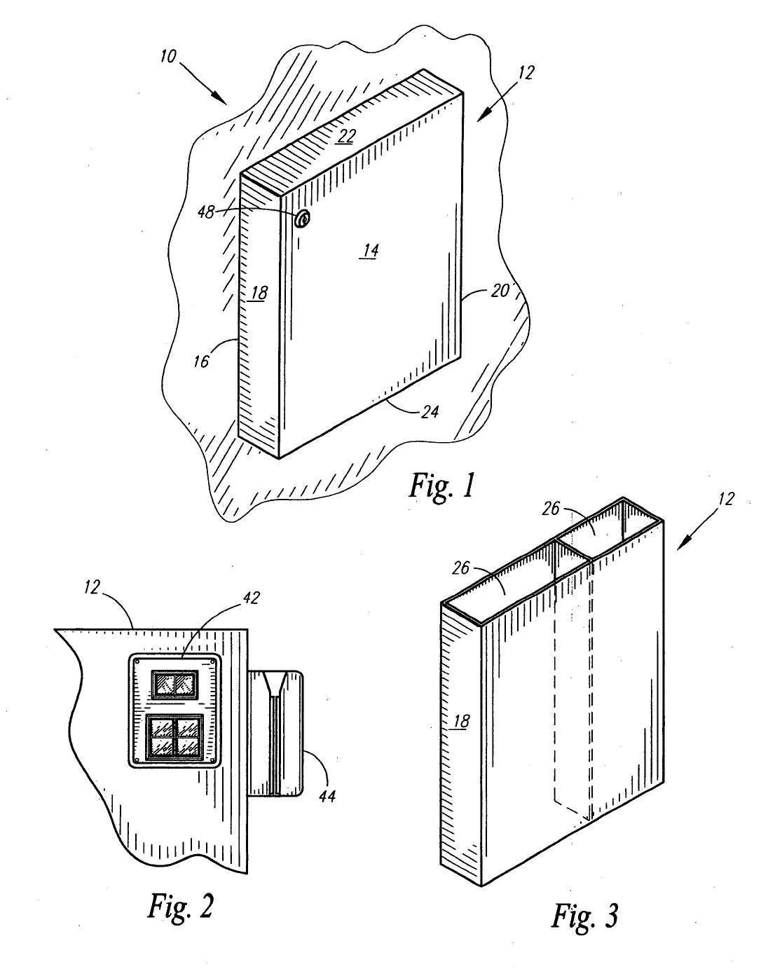

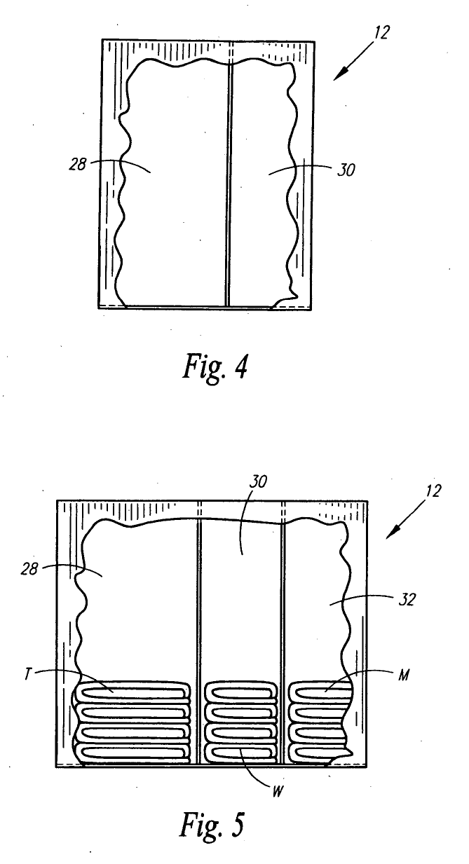

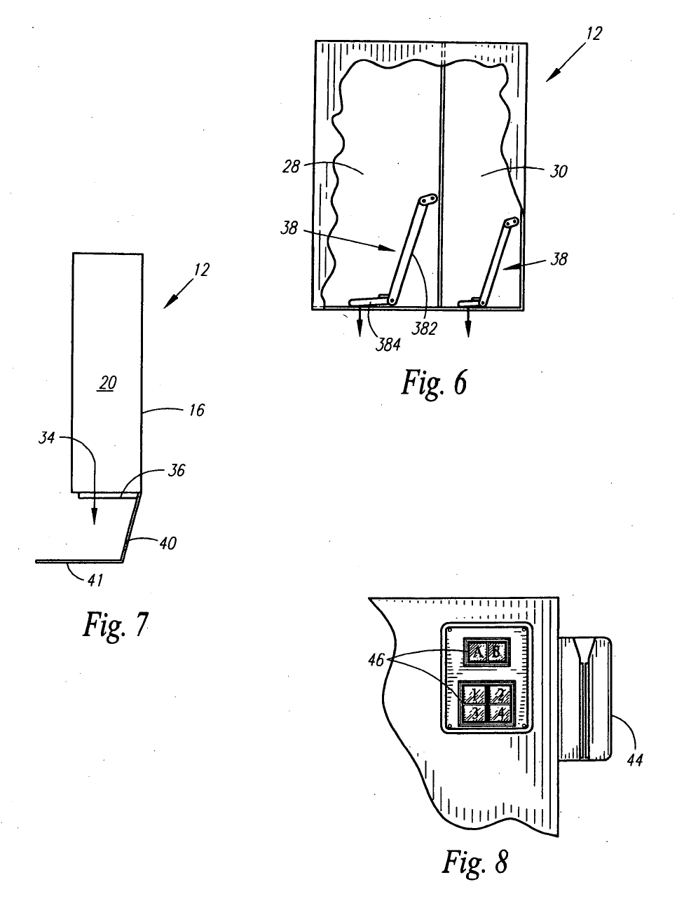

In accordance with one embodiment and as depicted in the drawings, FIG. 1 through FIG. 8, a dispenser housing one or more articles for dispensing per request is depicted in accordance with an embodiment of the dispenser, generally denoted by the reference character 10 (hereinafter “apparatus” or “dispenser”). The dispenser 10 comprises a housing 12 of variable shape and dimension, generally envisioned to encompass at least two types of articles, which may include towels “T” and wash cloths “W” representative of a few examples. The housing 12 has a three-dimensional configuration so as to form an internal volume that is divided into at least two magazines. Generally, the housing 12 comprises a plurality of walls 14, 16, 18, 20, 22 and 24 to form a six-face object forming the internal volume 26, and further housing the magazines 28 and 30. An additional magazine or magazines 32 is/are envisioned. In this configuration, walls 14, 16 are opposing, walls 18, 20 are opposing and walls 22, 24 are opposing. It is envisioned that wall 24 may be formed of a door or doors 36, the door(s) 36 selectively openable for dispensing selected article(s) to the user.

Depending upon the mounting of the dispenser 10 to a wall or other object, it is envisioned that at least one of the walls is removable or openable in such a manner so as to provide access to the internal volume 26, thereby permitting one to fill or remove articles as needed. It is envisioned that the apparatus may possess a lock 48 that prevents tampering or theft of the contents, such that lock 48 releases one of the walls for removal, providing access to the internal volume 26 therein.

Each magazine or article chamber 28 (30, 32) is a vertically aligned and elongated element storing a stackable article, such as a folded towel “T” or wash cloth “W”, in addition to miscellaneous articles “M”. The magazine or chamber 28 (30, 32) terminates at a discharge opening 34 communicating with the wall 24 and any door or doors 34 forming part of the wall 24. The housing 12 includes a dispensing mechanism 38, and possibly multiple dispensing mechanisms, for controlling the quantity and delivery of the article(s) selected by a user. Generally, the dispensing mechanism 38 controls the number of articles dispensed through the discharge opening 34 and door(s) 36.

The dispensing mechanism 38 may comprise a variety of elements, configurations and arrangements, including apparatuses or devices known in the prior art. The dispensing mechanism 38 may be actuated by mechanical/physical means or by electronic signal, or a combination of mechanical and electronic means. For example, it is envisioned that a dispensing mechanism 38 similar to and consistent with the mechanical arrangement and function of that found in U.S. Pat. No. 5,167,345 may be suitable for use herein. The dispensing mechanism 38 may comprise a pair of pivoting levers 380 and 384 interconnected and operable through a mechanical link 382, such that when the first lever 380 is urged, the link 382 urges the second lever 384 to lower an article or the articles through the discharge opening 34 and door 36, and then return to a non-discharging position. In this configuration, a deflected member 40 may be coupled at the end of the opening 34 and door 36, thereby dispensing one article per discharge and inhibiting a larger quantity of the stacked articles from discharging unnecessarily. The deflected member 40 may further include a horizontally and planar platform 41 upon which the dispensed article may temporarily rest or reside until the user collects the article. Alternatively, a stop or boss may be utilized to prevent additional dispensing of articles from the selected stack. This is but one example and is not to be construed as a limitation on the mechanical and/or electronic, or combination means for implementing a manner to dispense articles selected by a user.

Other dispensing mechanism 38 arrangements are contemplated and envisioned, including configurations in which the quantity is pre-selected before the door 36 is urged open. This may involve more intricate electronic and mechanical elements, including a lift or platform and a storage media or memory with executable instructions interoperable with optical means or sensors, as appropriate, thereby having the ability to intelligently discern between individual articles with a stack of articles and select the appropriate quantity as input by user.

The housing 12 may further include a communication unit 42 interoperable with the mechanical and/or electronic elements of the dispensing mechanism 38, thereby controlling the type and quantity of article selected for dispensing. The communication unit 42 comprises a reader 44 capable of decoding information stored on a portable storage medium, such as a card with a magnetic strip, bar code or other means for encoding information thereon. The portable storage medium engages the reader 44, and upon verification by the central process unit or memory that the medium and/or the requesting party may request additional articles, the user may input the type and quantity of article using an interface 46, such as a key pad or touch-screen. After input is received, the dispensing mechanism 38 is engaged to dispense one or more articles of a type via one or more of the means described above.

The reader 44 may be configured in a variety of ways, and combinations, so that the reader 44 may read and decode one or more types of portable storage media at one point of contact. For example, a magnetic strip or stripe is one manner for encoding information onto a card, including driver's licenses, credit cards, debit cards and other such instruments. The reader 44 may include means for swiping and decoding the information from a magnetic strip or stripe in the common and conventional manner by which most consumers are familiar. Additionally, the reader 44 may include means for optically detecting information images stored on the media, which then may be decoded by executable instructions or some other means. It is further contemplated that the reader 44 may include a radio frequency tag reading means and/or smart card reading means for remotely detecting and decoding information stored on the media. For example, storage media possessed by a smart cellular phone may be detectable through available wireless means, such as the popular Bluetooth® wireless technology, or other similar technologies available or developing. The physical arrangement of elements and component parts may be assembled from any one, or a combination of, the prior art available in the area of storage media readers, thus it is not necessary to exhaustively detail the envisioned reader configuration contemplated herein, other than to note it is envisioned that most commercially available reader configurations, and those presently developing, may be integrated into the general apparatus 10 disclosed herein without departing from the scope and substance of the apparatus.

The interface or selection menu 46 may comprise a variety of elements, including input/output (“I/O”) exchanges for smarter and more effective communication between the user and the communication unit 42. A key pad or touch-screen providing input options, including the selection of type of article and the quantity of the article, are envisioned. The quantity of an article may be limited by the unit 42 and interface 46, including having a maximum quantity input on the key pad or touch-screen (e.g. four (4) may be the most towels or wash cloths that may be requested per day—and the quantity selection may include buttons or entries up to the quantity of four (4)). Alternatively, the limitation may be in response to information encoded on the portable storage media the user may be using at the unit 42, and may be based on a variety of factors, including nightly rate, number of persons included on the account, frequent visitor benefits, or other similar items. A display or readout may be included for visually communicating information from the unit 42 to the user, including information such as the user's selection limit(s) or other important information.

It is further envisioned that the electronic means for detecting and quantifying the article(s) remaining within the housing 12 may be included in the apparatus 10. For example, an optical or mechanical means may be provided which periodically determines the quantity of towels and/or wash cloths remaining in each magazine, and may display or transmit such information upon request by an authorized user. Authorization may be gained by input key selections, or by decoding information from the authorized user's portable storage medium, or some other suitable means. In this manner, employees or authorized personnel may avoid unnecessarily checking the contents of the apparatus.

It is to be understood that the embodiments and claims are not limited in its application to the details of construction and arrangement of the components set forth in the description and illustrated in the drawings. Rather, the description and the drawings provide examples of the embodiments envisioned, but the claims are not limited to the specific embodiments. The embodiments and claims disclosed herein are further capable of other embodiments and of being practiced and carried out in various ways, including various combinations and subcombinations that may not have been explicitly disclosed. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claims appended hereto.

What I claim is:

1. An apparatus for dispensing articles comprising:
a housing having at least two magazines, each magazine having a discharge opening abutted by a selectively openable door;
a dispensing mechanism selectively releasing at least one article from one of the magazines; and
a communication unit interoperable with the dispensing mechanism and the housing, the communication unit having a reader and a selection menu.

2. An apparatus for dispensing articles comprising:
a housing having at least two magazines, the housing having a removable cover for access to the magazines, each magazine having a discharge opening abutted by a selectively openable door;
a dispensing mechanism selectively releasing at least one article from one of the magazines, the at least one article dispensed through the discharge opening and the openable door;
a communication unit interoperable with the dispensing mechanism and the housing, the communication unit having a reader and a selection menu;
the reader processing information encoded on a storable and portable medium, the information decodable via the reader; and
the selection menu having at least an article selection input and a quantity selection input.
